(19) United States
(12) Patent Application Publication
(10) Pub. No.: US 2012/0109713 A1
(43) Pub. Date: May 3, 2012

(54) SYSTEM AND METHOD FOR SELECTING A CERTIFIED CONTRACTOR

(76) Inventor: Michele Wilhite, San Diego, CA (US)

(21) Appl. No.: 13/287,439

(22) Filed: Nov. 2, 2011

Related U.S. Application Data
(60) Provisional application No. 61/409,192, filed on Nov. 2, 2010.

(51) Int. Cl. G06Q 30/02; G06Q 30/00

(52) U.S. Cl. 705/7.32; 705/26.35; 705/26.4

(57) ABSTRACT

The present invention relates generally to a management method and system for the selection of a reliable, trusted and safe certified contractor from a proprietary information database. More particularly the database will contain contractors that have undergone a thorough background investigation so that only company and individual contractors satisfying the certification requirements can be allocated to homeowners.

### CROSS REFERENCES

This application claims priority from U.S. Provisional Patent Application Ser. No. 61/409,192 filed Nov. 2, 2010 incorporated herein in its entirety by this reference.

### FIELD OF INVENTION

The present invention relates to a system and method for selecting a certified contractor. More particularly, but not exclusively, the present invention relates to a system and method for selecting a certified contractor by which homeowners are able to select a prescreened, trusted, reliable and safe contractor based on information collected and maintained in a proprietary database.

The present invention is a system and method which facilitates the selection and matching of certified contractors from a proprietary database with requesters based on a plurality of selection criteria including background checks and work history.

### BACKGROUND OF THE INVENTION

Beginning a home improvement project or even a repair can be an overwhelming task for a homeowner. Trying to find an honest, reputable, safe contractor or service provider that will provide quality workmanship can seem daunting and time consuming. There are several aspects a homeowner should investigate before selecting a person or persons to work in their home. A homeowner must find qualified contractors that work in their geographic area as well as the desired field of work. This is usually accomplished by a telephone directory or an internet search. However, the homeowner has little knowledge about the company or contractor they are contacting and even potentially selecting. Generally, the homeowner has no control over the process and has no assurances that the work will be performed in a satisfactory manner.

In order to perform a thorough search a homeowner has to spend valuable time in their investigative efforts. When researching contractor information a homeowner would like to compare work and rates, check for complaint history, interview potential providers, and call references. A more concerning issue for many homeowners is safety. Allowing a contractor access to the home exposes a homeowner to several risks including possible fraudulent and criminal activity. The contractor is aware of the home's location, layout, time when persons are home, who lives in the home, the contents of the home and potential access to financial accounts and other personal information. Exposing all of this information makes a homeowner an easy target for criminal activity. There have been numerous news stories regarding incidents with contractors, from an elderly person being swindled out of thousands of dollars, to theft of fine jewelry to even a murder. A homeowner has to be vigilant in their research prior to inviting a contractor into their most protected place, their home.

Unfortunately, all too often persons with criminal backgrounds seek positions within the construction, contractor or home service provider industries. Background checks are one of the most reliable ways to determine the character of potential contractors or service providers. This will provide awareness of past issues with the law or previous employers, as well as a determination of whether or not this person should be trusted entering the homes of others. It is vitally important that a homeowner feel safe and secure when selecting a stranger to work within their home. In the end a homeowner wants to protect their interests and work with a contractor that can be trusted.

Currently, companies will provide potential clients or a homeowner access to contractor databases whereby the homeowner can select a contractor based on their current need operating much in the same way as a telephone directory via the internet. However this method falls short for the homeowner with higher expectations. These companies fail to provide background checks, do not archive work history and fail to protect the homeowners from potential risks. It is an object of the present invention to overcome these shortcomings and provide the public access to contractors that have been prescreened, researched, selected and recommended based on their quality, reputation, work history and background in a timely fashion. This invention is a comprehensive safety net namely, a novel method and system for allocating a certified contractor with a homeowner that requires adherence to the strictest criteria.

### SUMMARY OF THE INVENTION

Various exemplary embodiments as described herein address the desirable aspects lacking in the relevant art and provide in various exemplary systematic, methodic, and computer program embodiments a method and system directed toward selecting a certified contractor from a proprietary database by a homeowner based on selection criteria including verification of work history and background checks.

The present invention is based, at least in part, on a valuable proprietary computer database containing contractor profiles, background information and archived work history. The database provides security to homeowners in that it can be used to select companies and contractors that have been researched to determine skill level, industry compliance, reliability, and most importantly safety.

In a preferred embodiment of the present invention, referred to herein as embodiment 1, a computer implemented method for selection of a certified contractor is provided comprising joining a network accessible database wherein the database contains information regarding a plurality of certified contractors, providing criteria to the database wherein the database generates a list of certified contractors based on the criteria provided, outputting the list of certified contractors and selecting at least one of the contractors from the list of certified contractors provided.

Another embodiment of the present invention, referred to herein as embodiment 2, is the computer implemented method according to embodiment 1 further comprising the steps of: (i) receiving the estimate for the work to be performed by the plurality of contractors listed, (ii) accepting the estimate for the work to be performed by one of the plurality of contractors listed, (iii) confirming an appointment date for the work to be performed by the contractor from step (ii) and (iv) receiving details of the appointment including contractor name, photographic identification, name of employees, identification number, work order number and confirmation of the estimate for the work to be performed. It is understood that embodiment 2 may also be practiced wherein steps (i) and (ii) are modified to comprise the steps of: (i) receiving the details for the work to be performed by the plurality of contractors listed, (ii) selecting a contractor for the work to be performed by one of the plurality of contractors listed, (iii) confirming an appointment date for the work to be performed by the contractor from step (ii) and (iv) receiving details of the appointment including contractor name, photographic identification, name of employees and identification number.

Another embodiment of the present invention, referred to herein as embodiment 3, is a system for selection of a certified contractor comprising a server operatively coupled to a communications network comprising, a processor, a computer readable storage medium operatively coupled to the processor, a database operatively stored in the computer readable storage medium.

Another embodiment of the present invention, referred to herein as embodiment 4, is the database of embodiment 3 divided into separate components, modules or engines for simplicity of explanation only.

Another aspect of embodiment 4 is a first database component operative to provide a plurality of certified contractors including results of a contractor background check, contractor services provided, contractor service record and identifying data associated with contractor.

Another aspect of embodiment 4 is a second database component operative to provide a plurality of user defined criteria wherein the plurality of user defined criteria includes user identifying data, membership data associated with a plurality of database users, information of the work to be performed and contact information.

Another aspect of embodiment 4 is a third database component operative to provide a plurality of administrative data including information contained within the first and second database components and data archived reflecting work history of the plurality of certified contractors.

Another embodiment of the present invention, referred to herein as embodiment 5, is the system according to embodiment 3 further comprising a user computer in networking communications with the server and configured to allow remote entry into the database components.

Another embodiment of the present invention, referred to herein as embodiment 6, is the system according to embodiment 5 further comprising executable instructions causing the processor to determine the plurality of certified contractors in dependence on the user defined criteria.

Another embodiment of the present invention, referred to herein as embodiment 7, is the system according to embodiment 6 further comprising executable instructions causing the processor to provide over the network to the user from the plurality of certified contractors an estimate of the work to be performed and requesting acceptance of one of the plurality of certified contractors; after acceptance of one of the plurality of certified contractors, provide to the user a request for acceptance of a date and time for the work to be performed by one of the plurality of certified contractors; after acceptance of the date and time for the work to be performed, provide to the user the name of one of the plurality of certified contractors performing the work, photographic identification of the selected certified contractor, identification number, work order number and confirmation of the estimate of the work to be performed. Another embodiment of the present invention, referred to herein as embodiment 7a, is the system according to embodiment 6 further comprising executable instructions causing the processor to provide over the network to the user a list of certified contractors. The user then contacts the contractor directly and arranges an appointment. The system is notified of the appointment by both the contractor and user. Prior to the day of the appointment the contractor will inform the user of the name and identification number of the worker and send photographic identification.

Another embodiment of the present invention, referred to herein as embodiment 8, is the system according to embodiment 3 further comprising executable instructions causing the processor to provide to the user a request for completion of a survey rating the quality of the work performed by the selected certified contractor.

Another embodiment of the present invention, referred to herein as embodiment 9, is a computer program product embodied in a tangible form comprising instructions executable by a processor coupled to a network causing the processor to store a network accessible database in a computer readable storage medium coupled to the processor; provide a plurality of certified contractors including results of a contractor background check, contractor services provided, contractor service record and identifying data associated with contractor; provide a plurality of user defined criteria and provide a plurality of administrative data including information contained within the first and second database components and data archived reflecting work history of the plurality of certified contractors.

Another embodiment of the present invention, referred to herein as embodiment 10, is the computer program product according to embodiment 9 further comprising instructions executable by the processor coupled to the network causing the processor to provide over the network to the user from the plurality of certified contractors an estimate of the work to be performed and requesting acceptance of one of the plurality of certified contractors; provide to the user a request for acceptance of a date and time for the work to be performed by one of the plurality of certified contractors; provide to the user the name of one of the plurality of certified contractors performing the work, photographic identification of the selected certified contractor, identification number, work order number and confirmation of the estimate of the work to be performed and provide to the user a survey rating the quality of the work performed by the selected certified contractor. Yet another embodiment of the present invention, referred to herein as embodiment 10a, is the computer program product according to embodiment 9 further comprising instructions executable by the processor coupled to the network causing the processor to provide over the network to the user a list of certified contractors. Before the work is performed the contractors will provide photographic identification of the selected certified contractor, identification number, and the network will provide a survey to be filled out at the completion of the job.

It is contemplated that any method, system or information described herein can be implemented with respect to any other method, system or information described herein.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1 depicts an exemplary block diagram of a server computer system;

FIG. 2 depicts a block diagram illustrating the method by which a contractor is registered as a certified contractor;

FIG. 3 depicts a block diagram illustrating the method by which a user selects a certified contractor; and

FIG. 4 depicts a block diagram illustrating how the system archives and maintains ratings for the certified contractors.

### DETAILED DESCRIPTION OF THE INVENTION

The present invention relates to a certified contractor selection method and system. The present invention will be described in relation to residential contractors. However, it will be appreciated that, with minor modifications, the system may be adapted for use with the placement of other forms or contractors including commercial, subcontractors and general contractors. The terms user and homeowner will be used interchangeably throughout the application.

There is a present need for a system that performs an additional level of scrutiny on contractors or service providers that will be working inside the home of another. This system and method will conduct the necessary research on behalf of a homeowner. Additionally, the method described will collect, record and archive contractor interactions with homeowners on multiple levels.

A networked server is provided that may be accessible by a public network. The networked server includes a processor, a memory coupled to the processor and at least a single database operatively stored in the memory. The database or alternatively databases comprises a plurality of service contractor records, each record being associated with a contractor including data representing the service contractor's services and background information. The database will additionally contain information regarding the users that utilize the database. A database is operatively loaded into the memory and includes instructions executable by the processor to determine a suggested contractor for a homeowner dependent upon the contractors' services and homeowner's needs.

The system and method will be described as being accessed and operated through the internet via a website accessible by homeowners through a standard internet browser. The contractor database will contain a wealth of information regarding home industry companies as well as individual contractors or employees. Only contractors or employees that have satisfied the background requirements will be admitted to the database.

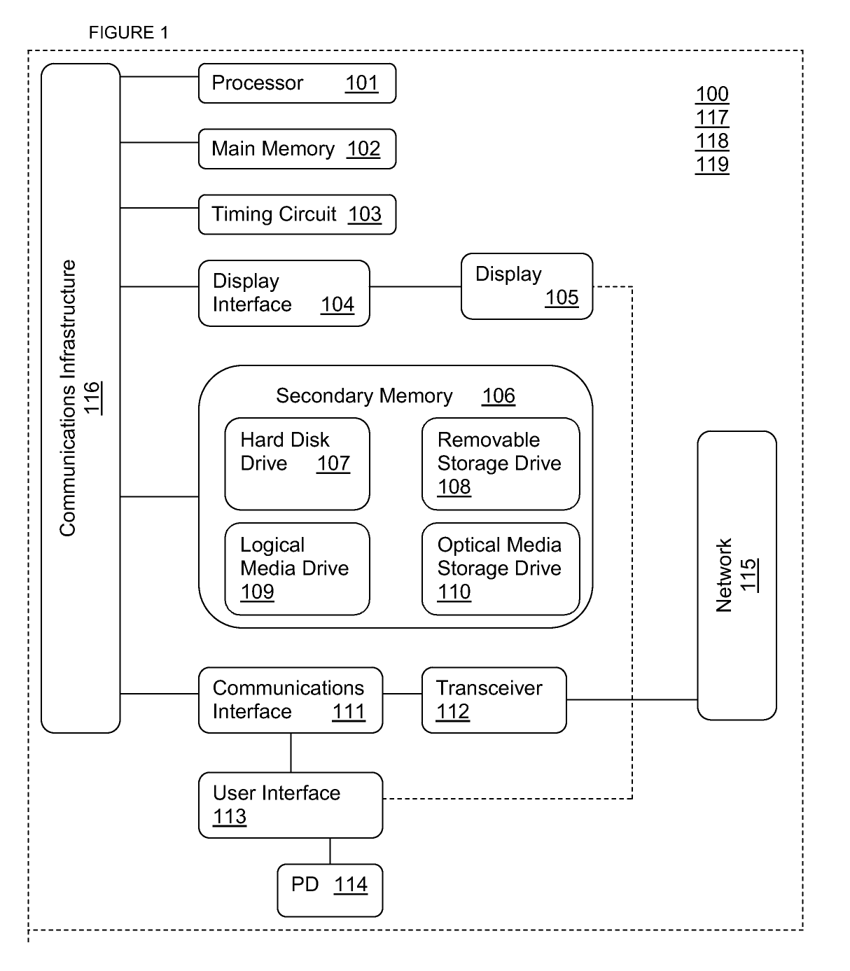

Referring to FIG. 1, a generalized block diagram of an exemplary computer system is depicted. The computer system is illustrative of a server 100 and plurality of networked clients 117, 118, 119. For simplicity and ease of understanding, the term “networked server” 100 will be used hereinafter. However, the same general computer configurations apply to the networked clients 117, 118, 119 as well.

The networked server 100 includes a communications infrastructure 116 used to transfer data and memory addresses where data files are to be found and control signals among the various components and subsystems associated with the networked server 100. As such, the communications infrastructure 116 provides the input/output (I/O) between and among the various components and subsystems associated with the networked server 100.

A processor 101 is provided to interpret and execute logical instructions stored in the memory 102. One skilled in the art will appreciate that one or more processors 101 may be provided in various server implementations and/or in multi-core integrated processor packages.

The main memory 102 is the primary general purpose storage area for instructions and data to be processed by the processor 101. The term “memory” is to be interpreted in its broadest sense and includes both main memory 102 and secondary memory 106. A collective term of “computer readable storage medium,” may be used to describe either or both the main memory 102 and secondary memory 106 as well.

Where applicable, references to the term “datastore” should be interpreted as an alternative to the terms “memory,” and “computer readable storage medium.” The memory includes the primary 102 and secondary memory 106. A timing circuit 103 is provided to coordinate programmatic activities within the computer 100 in near real time. The timing circuit 103 may be used as a watchdog timer, clock or a counter arrangement and may be separately programmable.

The processor 101, main memory 102 and timing circuit 103 are directly coupled to the communications infrastructure 116. A display interface 104 is provided to drive a display 105 associated with the networked server 100. The display interface 104 is electrically coupled to the communications infrastructure 116 and provides signals to the display 105 for visually outputting both graphical displays and alphanumeric characters.

The display interface 104 may include a dedicated graphics processor and memory (not shown) to support the displaying of graphics intensive media. The display 105 may be of any type (e.g., cathode ray tube, gas plasma) but in most circumstances will usually be a solid state device such as liquid crystal display (LCD.) A secondary memory subsystem 106 is provided which houses retrievable data storage units such as a hard disk drive 107, an optional removable storage drive 108, an optional logical media storage drive 109 and an optional optical media storage drive 110.

The removable storage drive 108 may be a replaceable hard drive, optical media storage drive or a solid state flash RAM device. The logical media storage drive 109 may include a flash RAM device, or an EEPROM encoded with instructions executable by the processor 101. The optical storage media storage drive 110 includes the ability to read and write compact disk (CD) and digital video disk (DVD) media form factors.

A communications interface 111 subsystem is provided which allows for standardized electrical connection of peripheral devices to the communications infrastructure 116 including, PSI2, serial, parallel, USB, and Firewire™ connectivity ports.

For example, a communications network transceiver 112 and a user interface 113 may be electrically coupled to the communications infrastructure 116 via the communications interface 111. The transceiver 112 facilitates the remote exchange of data and synchronizing signals between the networked server 100 and other devices in network communications 115 with the networked server 100. The transceiver 112 is envisioned to be of type normally associated with computer networks based on the various IEEE standards 802.x, where x denotes the various present and evolving wireless computing standards, for example IEEE 802.11; 802.11a, b, g, n; WiMax IEEE 802.16 and WRANG IEEE 802.22.

Alternately, digital cellular communications formats compatible with for example GSM, 3G, CDMA, TDMA and evolving cellular communications standards. Both peer to peer (P2P) and client-server arrangements are envisioned for implementation of the various exemplary embodiments.

For purposes of this specification, the term “user interface” 113 includes the hardware and software by which a user interacts with the networked server 100 and the means by which the networked server 100 conveys information to the user. The user interface 113 may include the display interface 104 and an operatively coupled display 105, for example, inventive embodiments utilizing a touch screen.

The user interface 113 employed may include a pointing device 114 such as a mouse, thumbwheel or track ball, an optional touch screen (not shown); one or more pushbutton switches (not shown), one or more sliding or circular potentiometer controls (not shown) and one or more additional switches (not shown.)

The user interface 113 provides interrupt signals to the processor 101 via the communications interface 111 and communications infrastructure 116 that may be used to interpret user interactions with the networked server 100. The networked server 100 includes an operating system, the necessary hardware and software drivers necessary to fully utilize the devices coupled to the communications infrastructure 116 and at least an Internet browser. The operating system may include the various versions and derivations of Unix™ Microsoft Windows™, and Apple™ MAC 0s-X. The Internet browser may be of any common type which is compatible with the operating system installed on the networked server 100.

Contractor Certification

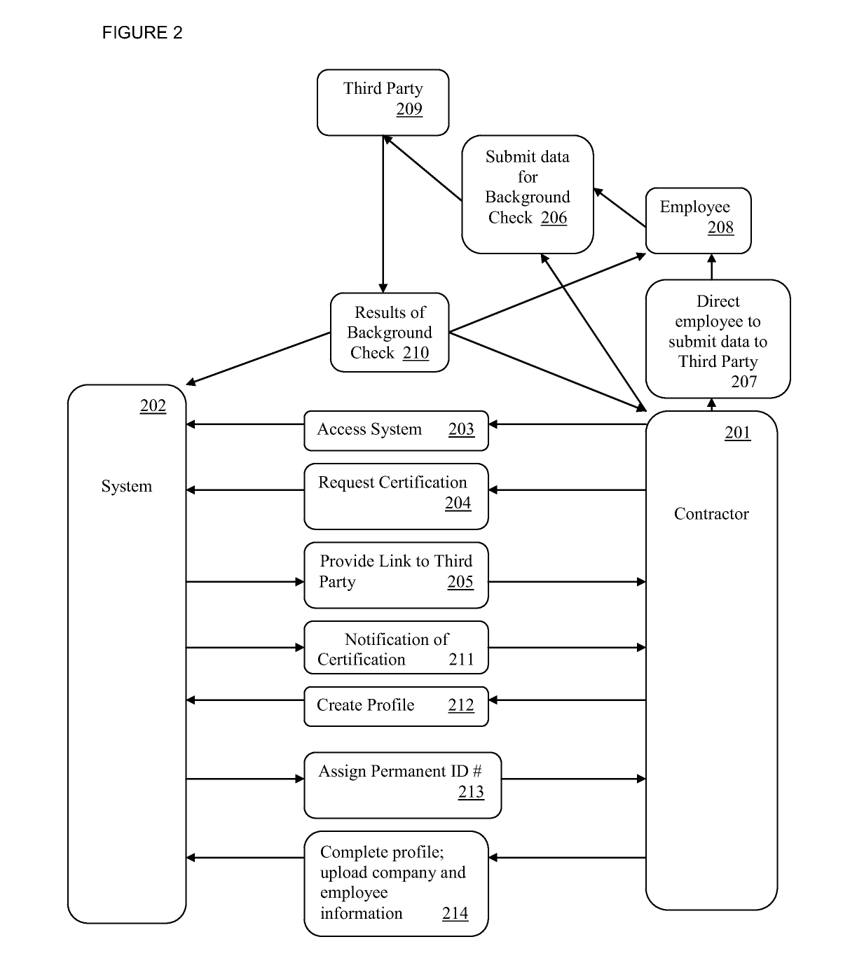

Referring now to FIG. 2 depicting a block diagram illustrating the method by which a contractor is registered as a certified contractor and included in the proprietary database.

Prior to a user accessing the database, contractors 201 would apply for inclusion in the system 202 as a certified contractor by submitting to a background screening. In an exemplary session, the contractor 201 seeking registration as a certified contractor will access the system 203. The contractor 201 will request to become a certified contractor 204 and listed in the proprietary database searchable by a plurality of users.

The contractor will be prompted by the system 202 to follow a hyperlink to an independent third party website 205 and submit all required information for initializing a background screening. For example the contractor may provide, corporate information, bonded, insurance, references, company history and a description of field of work. The submission may also include financial condition of the company, Better Business Bureau records, licenses, civil and criminal records, customer recommendations and referrals.

In addition to a background screening being performed on the contractor 201, the contractor 201 will direct any employees they wish to have individually certified to submit all required information to the third party website 207 for initializing a background screening. All employees 208 the contractor 201 will be using for any jobs obtained through the system 202 must be certified. Both contractors 201 and employees 208 will submit all required data 206 to the third party 209 for completion of the background screening. The proper background checks will be completed on the company as well as the individual employees of the contractor 201 that desire certification. It is also possible that individual contractors will seek certification as an added credential for employment reasons.

The independent third party 209 will verify the information submitted by the contractor 201 and employees 208. Information regarding criminal behavior, complaints, insurance, licenses, bonding will all be verified through the appropriate independent agencies.

Upon completion of all background screening requirements the contractors 201 and employees 208 that have successfully passed the background screening process will be notified of the results 210. The system 202 will also receive the results of the background screening and will notify 211 the contractor 201 of their inclusion in the proprietary database searchable by a plurality of users.

The contractor 201 will be able to create a profile 212 within the system to ease the process of accessing the system 202 in the future. Creation of the profile may contain username and password, detailed company information, location and breadth of services.

The contractor 201 and employees 208 that have successfully passed the certification process will be assigned a permanent identification number 213. This unique identifying number will be used to track, record and archive all information related to the company or person the number is assigned. It is contemplated that periodic updates will be performed to verify continued passing results for background information. These periodic updates will be used in conjunction with consumer ratings of work completed. Once a contractor is assigned a number the contractor 201 will be known by the system 202.

The contractor 201 will be able to create, customize and display additional information such as photographs or video of the services the contractor provides 214. The contractor can update and add information as necessary to its profile 214. This will be viewable by a plurality of users accessing the database.

The list of certified contractors is maintained by the database and can be sorted in a plurality of ways including, geographically, type of repair, size of company, years in business, ratings, and the like. This list will be accessible to the end user via the computer interface.

### Selecting a Contractor

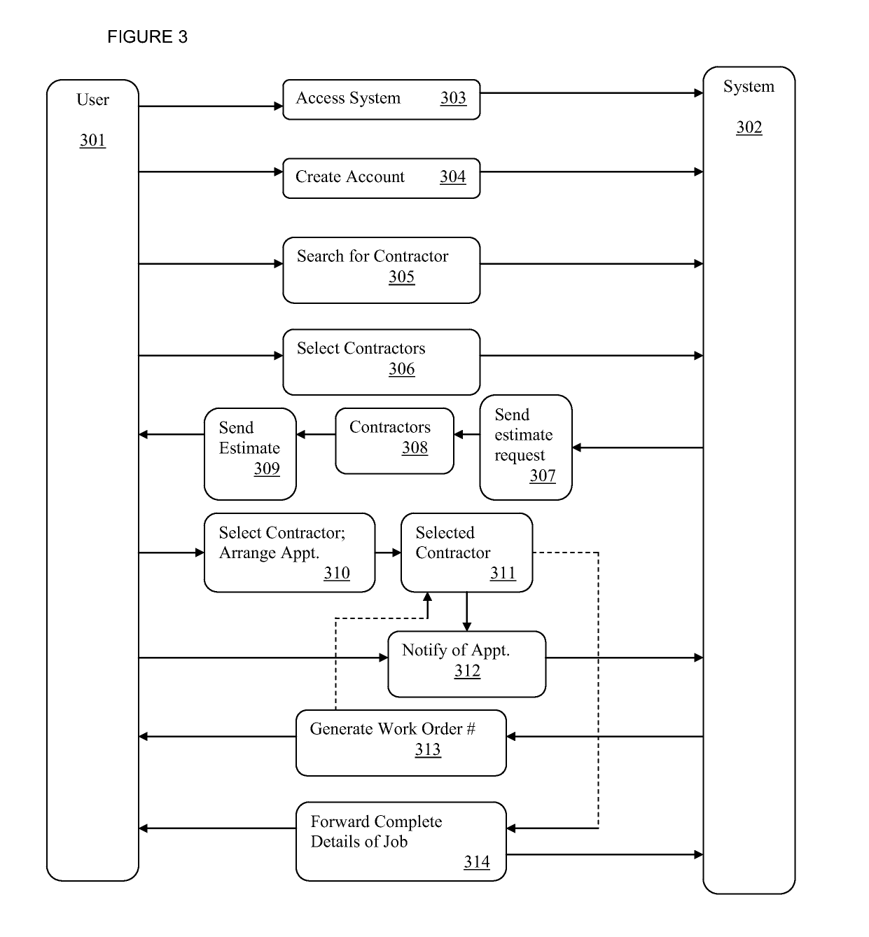

Referring now to FIG. 3, illustrating how the user 301 would interact with the system 302 to select a certified contractor. In an exemplary session, a user 301 has a need to request a contractor's services. The user 301 would access the system 303 through an internet browser.

The user 301 will be prompted to create an account 304 by submitting all required information to the system. This information may include a user ID, password, selection of membership level, payment of any required fees dependent upon membership level, contact information, the job to be performed, location, etc., but in all cases the information will remain confidential by the system 302.

As a registered user, the user 301 will be prompted to submit a query to the system to perform a search for a certified contractor 305. A keyword search is one possible way a user 301 could locate the certified contractors that fit their present need. The user 301 could search by geographic area, type of work to be performed, rating level, etc. The user 301 will input work related information defining the details of the job including the scope of work, timing and budget. It is also possible the user 301 would like the system 302 to select the at least one certified contractor on behalf of the user 301. In another aspect it shall be understood that the user 301 can select or alternatively the system 302 could select a certified contractor matching the user's needs. The system 302 will display a list of certified contractors, according to the query submitted, for the user to select 306. As a registered user, the user 301 will be prompted to submit a query to the system to perform a search for a certified contractor 305. A keyword search is one possible way a user 301 could locate the certified contractors that fit their present need. The user 301 could search by geographic area, type of work to be performed, rating level, etc

The user 301 will be able to view and select 306 at least one of the contractors for the system or database to contact 307 and request an estimate of the work to be performed.

In an alternative embodiment, the contractors 308 will be contacted by the system 307 requesting an estimate for the user 301. One possible way the selected contractor or contractors 308 can be contacted is through an automatically generated email. In the email, the contractors 308 will be provided with the user's email address as well as the job information. The contractors 308 will then be able to respond to the user to provide further information including an estimate 309. This will maintain the confidentiality of the user by not exposing phone numbers, or address information. The user 301 and the selected contractor 311 can arrange an appointment 310 for the work to be performed.

After selection of an appointment for services 310, the system 302 will be notified 312 by the selected contractor 311 and the user 301 of the impending work or appointment. In one preferred embodiment, the system 302 will provide the contractor with a unique identifying work order number 313. It is contemplated that this number will be job specific and linked to the contractor's certification number as discussed above. The user 301 will be provided with this job specific number 313 for reference. The selected contractor 311 will generate a set of documents describing the history of the relationship and transactions between contractor and user 314. The documents will include the work to be performed, a cost estimate and future details. The user 301 will then be contacted with the identifying information 314 for the certified contractor. The contractor arrives at the home and will present the user with the documents as well as a photo ID. The documents should contain the same specific work order number that the homeowner has on file. Alternatively, if no work orders are employed, the contractor arrives at the home and will present the user with the documents as well as a photo identification.

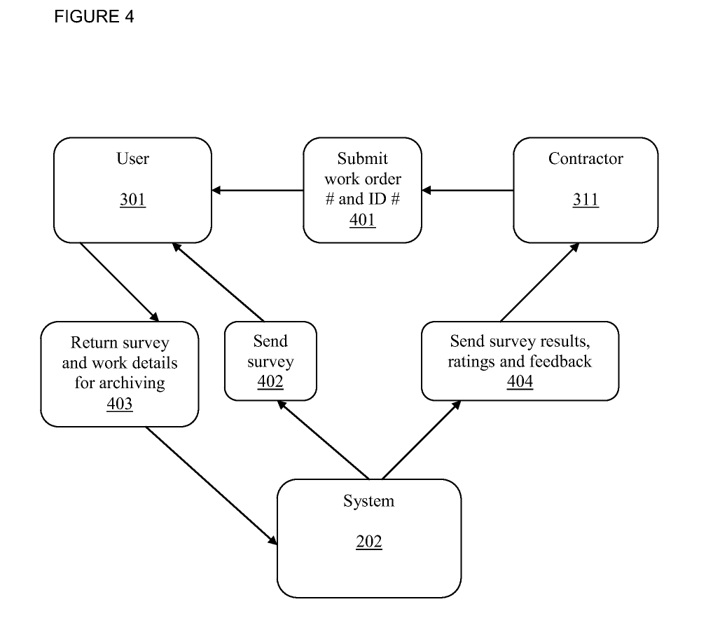

Referring now to FIG. 4, illustrating how the system archives and maintains ratings for the certified contractors.

On the day the selected contractor 311 arrives to perform the agreed upon work, the selected contractor 311 will submit the unique identifying work order number and ID number 401 to the homeowner for comparison to the information submitted by the system 202 to the homeowner. Upon completion of the agreed upon work, the user 301 will be able to fill out a survey based on their experience. Alternatively, on the day the selected contractor 311 arrives to perform the agreed upon work, the selected contractor 311 will submit the unique ID and photo ID to the homeowner. The system 202 will forward a brief survey 402 detailing the initial meeting of the user and contractor, the user satisfaction of the work performed, details of the work performed and ratings information. One possible way the survey can be sent is through an automatically generated email. Some of the possible questions included in the survey could be:

Did the contractor arrive on schedule?
Do you feel the cost was reasonable and fair for the work performed?
How was the quality of work?
Was the contractor professional?
What rating would you give the contractor?
Would you use the system again?
How likely would you be to recommend the system to others?

The survey and work details will be returned 403 by the user 301 to the system 202. The work details will be archived in the proprietary database. The archived work details provide an additional layer of security for the user. In the event the user needs to locate records of previous work details, the proprietary database is easily accessible by the user to locate and pull the relevant documents. The survey results will be sent 404 by the system 202 directly to the selected contractor 311. The certified contractor may also designate a company representative to receive such surveys. The survey results will be added to the contractors profile and rating.

The rating scale can be any type of scale, alphanumeric or pictorial, that would allow a user to ascertain the level of performance. The contractor can be assigned a competency or proficiency level by the system. This proficiency level will be determined by education level, years in business, work history, self rating and homeowner ratings. These ratings can be adjusted at any time to reflect the current status of the contractor or its employees. The history will also be automatically updated once the contractor has performed work through the system.

The survey information is also helpful to the contractors supervisor. It will provide valuable feedback of the employee's performance or how the customer views the employee. It is another aspect of this invention that the system will be capable of running reports wherein a supervisor could request all the feedback and details for a job in relation to the particular certification number for an individual employee.

Methods and materials are described herein. However, methods and materials similar or equivalent to those described herein can be also used to obtain variations of the present invention. The materials, methods, and examples are illustrative only and not intended to be limiting.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed:

1. A computer implemented method for selection of a certified contractor comprising:
joining a network accessible database wherein the database maintains information regarding a plurality of certified contractors;
providing criteria to the database wherein the database generates a list of certified contractors based on the criteria provided;
outputting the list of certified contractors; and
selecting at least one of the contractors from the list of certified contractors provided.

2. The computer implemented method according to claim 1 wherein joining the network accessible database is accomplished by creating an account with unique identifying information.

3. The computer implemented method according to claim 1 wherein the criteria provided includes type of work to be performed, rating level, work history, company identifying information, availability and geographic location.

4. The computer implemented method according to claim 3 wherein the network accessible database is stored on a server and the browser is connected to the server over a network.

5. The computer implemented method according to claim 4 wherein the network is the internet.

6. The computer implemented method according to claim 1 wherein the information contained in the database includes services offered by the plurality of certified contractors.

7. The computer implemented method according to claim 1 wherein the plurality of certified contractors contained in the network accessible database has been screened using a background check.

8. The computer implemented method according to claim 7 wherein the background check is performed by an independent third party.

9. The computer implemented method according to claim 8 wherein the independent third party performs the background check based upon information provided by the contractors.

10. The computer implemented method according to claim 9 wherein the information provided by the plurality of contractors includes company information.

11. The computer implemented method according to claim 1 wherein selection of at least one of the plurality of contractors listed solicits an estimate for the work to be performed by the contractors listed.

12. The computer implemented method according to claim 12 further comprising the steps of;
(i) receiving the estimate for the work to be performed by the plurality of contractors listed;
(ii) accepting the estimate for the work to be performed by one of the plurality of contractors listed;
(iii) confirming an appointment date for the work to be performed by the contractor from step (ii).
(iv) receiving details of the appointment including contractor name, photographic identification, name of employees, identification number, work order number and confirmation of the estimate for the work to be performed.

13. A system for selection of a certified contractor comprising:
a server operatively coupled to a communications network comprising;
a processor;
a computer readable storage medium operatively coupled to the processor;
a database operatively stored in the computer readable storage medium, the database comprising;
a first database component operative to provide a plurality of certified contractors including results of a contractor background check, contractor services provided, contractor service record and identifying data associated with contractor;
a second database component operative to provide a plurality of user defined criteria wherein the plurality of user defined criteria includes user identifying data, membership data associated with a plurality of database users, information of the work to be performed and contact information;
a third database component operative to provide a plurality of administrative data including information contained within the first and second database components and data archived reflecting work history of the plurality of certified contractors.

14. The system according to claim 14 further comprising a user computer in networking communications with the server and configured to allow remote entry into the database components.

15. The system according to claim 15 further comprising executable instructions causing the processor to determine the plurality of certified contractors in dependence on the user defined criteria.

16. The system according to claim 16 further comprising executable instructions causing the processor to;
provide over the network to the user from the plurality of certified contractors an estimate of the work to be performed and requesting acceptance of one of the plurality of certified contractors;
after acceptance of one of the plurality of certified contractors, provide to the user a request for acceptance of a date and time for the work to be performed by one of the plurality of certified contractors;
after acceptance of the date and time for the work to be performed, provide to the user the name of one of the plurality of certified contractors performing the work, photographic identification of the selected certified contractor, identification number, work order number and confirmation of the estimate of the work to be performed.

17. The system according to claim 14 further comprising executable instructions causing the processor to provide to the user a request for completion of a survey rating the quality of the work performed by the selected certified contractor.

18. A computer program product embodied in a tangible form comprising instructions executable by a processor coupled to a network causing the processor to:
store a network accessible database in a computer readable storage medium coupled to the processor;
provide a plurality of certified contractors including results of a contractor background check, contractor services provided, contractor service record and identifying data associated with contractor;
provide a plurality of user defined criteria wherein the plurality of user defined criteria includes user identifying data, membership data associated with a plurality of database users, information of the work to be performed and location of the user;
provide a plurality of administrative data including information contained within the first and second database components and data archived reflecting work history of the plurality of certified contractors.

19. A computer program product according to claim 18 further comprising instructions executable by the processor coupled to the network causing the processor to:
provide over the network to the user from the plurality of certified contractors an estimate of the work to be performed and requesting acceptance of one of the plurality of certified contractors;
provide to the user a request for acceptance of a date and time for the work to be performed by one of the plurality of certified contractors;
provide to the user the name of one of the plurality of certified contractors performing the work, photographic identification of the selected certified contractor, identification number, work order number and confirmation of the estimate of the work to be performed;
provide to the user a survey rating the quality of the work performed by the selected certified contractor.
